(19) United States
(12) Patent Application Publication
(10) Pub. No.: US 2019/0293170 A1
(43) Pub. Date: Sep. 26, 2019

(54) METHOD FOR ASSEMBLING A PLANETARY GEARBOX, A PLANETARY CARRIER AND AN AIRCRAFT ENGINE

(71) Applicant: Rolls-Royce Deutschland Ltd & Co KG, Blankenfelde-Mahlow (DE)

(72) Inventors: Jan SCHWARZE, Berlin (DE); Christos KALLIANTERIS, Berlin (DE)

(21) Appl. No.: 16/358,313

(22) Filed: Mar. 19, 2019

(30) Foreign Application Priority Data
Mar. 22, 2018 (DE) 10 2018 106 864.6

(51) Int. Cl. F16H 57/08; F16H 1/28; F02C 7/36; F02K 3/06

(52) U.S. Cl. CPC F16H 57/082; F16H 1/28; F16H 2057/0056; F02K 3/06; F02C 7/36

(57) ABSTRACT

A method for assembling a planetary gearbox, wherein the planetary gearbox has a planetary carrier for mounting planetary gears, and wherein at least one of the planetary gears is inserted from the outside in the radial direction into an opening that is located at the circumference of the planetary carrier, the at least one planetary gear is then moved radially in the outward direction to the circumference of the planetary carrier, subsequently a sun gear is inserted through an opening in the center of the flat side wall of the carrier, and subsequently the at least one planetary gear is moved radially inward for engagement with the sun gear. A planetary carrier and an aircraft engine.

This application claims priority to German Patent Application DE102018106864.6 filed Mar. 22, 2018, the entirety of which is incorporated by reference herein.

The present invention relates to a method for assembling a planetary gearbox with the features of claim 1, a planetary carrier of a planetary gearbox with the features of claim 6, and an aircraft engine with the features of claim 10.

In fan gear engines for aircrafts, reduction gears are used to reduce the rotational speed of a fan as compared to a driven turbine. The planetary gearboxes that are used for this purpose are supposed to be effectively mountable. What is known from U.S. Pat. No. 8,667,688 B2 is a method in which all gear wheels are inserted through a central opening in the side walls of the planetary carrier.

There is the objective to provide efficient methods and planetary carriers.

This objective is achieved through a method according to claim 1.

Here, the focus is on the assembly of a planetary gearbox, wherein the planetary gearbox has a planetary carrier for mounting planetary gears.

Here, at first at least one of the planetary gears is inserted in the radial direction from the outside into an opening that is located at the circumference of the planetary carrier (also referred to as a carrier). In many cases, all planetary gears (e.g. 3 to 5 planetary gears) are respectively inserted through the radial openings into the planetary carrier in this way. Thus, the planetary gears are inserted through the openings at the circumference of the planetary carrier.

Subsequently, the at least one planetary gear is moved radially in the outward direction to the circumference of the planetary carrier.

Now, the sun gear is inserted through an opening in the center of the flat side wall of the planetary carrier, and subsequently the at least one planetary gear is moved radially inward for engagement with the sun gear.

In this manner, efficient mounting of the structural components of the planetary gearbox is facilitated.

In one embodiment, the at least one planetary gear is inserted into the radial opening of the planetary carrier with an angular pre-alignment.

It is also possible for the at least one planetary gear to be displaced inside the planetary carrier by an angular amount with respect to the rotational axis of the planetary carrier so as to be inserted into a bulge in the radial housing of the planetary carrier.

In a further embodiment of the method, the planetary gears have respectively two planetary gear elements that are arranged in parallel to each other, wherein the planetary gear elements respectively have a helical gearing, and the planetary gear elements are arranged in such a manner that the helical gearings are counter-rotating.

Also, in a further embodiment of the method, an axial setting of the sun gear is performed following the movement of the at least one planetary gear radially inward.

The objective is also achieved through a planetary carrier of a planetary gearbox with the features of claim 6. Here, radial openings are provided at the circumference which are adjusted to the size and shape of the at least one planetary gear. Here, at least one radial opening of the planetary carrier can have a rectangular cross section, wherein the width of the opening is substantially equal to or larger than the diameter of the at least one planetary gear.

A good mechanical stability against any deformation of the planetary carrier is present when at least one web of the planetary carrier, i.e. the area between two planetary gears, has a trapezoid cross section.

Additionally or alternatively, the stability of the planetary carrier can be increased by embodying the side walls of the planetary carrier without any holes, except for the central opening for the sun gear.

The objective is achieved by an engine for an aircraft with the features of claim

Here, the engine comprises a core engine with a turbine, a compressor and a core engine shaft for connecting the turbine to the compressor, and a fan upstream of the core engine, wherein the fan has a plurality of blades. The engine further comprises a planetary gearbox that is connected on the entry side to the core engine shaft, and is connected to a fan on the exit side to the drive in such a manner that the rotational speed of the fan is lower than the rotational speed of the core engine shaft. At that, the planetary gearbox has a planetary carrier according to at least one of the claims 6 to 9.

As noted elsewhere herein, the present disclosure may relate to a gas turbine engine, such as for example an aircraft engine. Such a gas turbine engine may comprise a core engine comprising a turbine, a combustion device, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for gear fans that are driven via a gearbox. Accordingly, the gas turbine engine may comprise a gearbox that is driven via the core shaft, with its drive driving the fan in such a manner that it has a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and the compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gearbox may be embodied to be driven by the core shaft that is configured to rotate (for example in use) at the lowest rotational speed (for example the first core shaft in the example above). For example, the gearbox may be embodied to be driven only by the core shaft that is configured to rotate (for example in use) at the lowest rotational speed (for example only by the first core shaft, and not the second core shaft, in the example above). Alternatively, the gearbox may be embodied to be driven by one or multiple shafts, for example the first and/or second shaft in the above example.

In a gas turbine engine as described and/or claimed herein, a combustion device may be provided axially downstream of the fan and the compressor (or the compressors). For example, the combustion device may be located directly downstream of the second compressor (for example at the exit thereof), if a second compressor is provided. By way of further example, the flow at the exit to the combustor may be provided to the inlet of the second turbine, if a second turbine is provided. The combustion device may be provided upstream of the turbine(s).

The or each compressor (for example the first compressor and the second compressor according to the above description) may comprise any number of stages, for example multiple stages. Each stage may comprise a row of rotor blades and a row of stator vanes, which may be variable stator vanes (i.e. in that their angle of incidence may be variable). The row of rotor blades and the row of stator vanes may be axially offset with respect to each other.

The or each turbine (for example the first turbine and second turbine according to the above description) may comprise any number of stages, for example multiple stages. Each stage may comprise a row of rotor blades and a row of stator vanes. The row of rotor blades and the row of stator vanes may be axially offset with respect to each other.

Each fan blade may have a radial span width extending from a root (or hub) at a radially inner gas-washed location, or from a 0% span position to a tip with a 100% span width. Here, the ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in a closed range bounded by any two values in the previous sentence (i.e., the values may represent upper or lower bounds). These ratios may commonly be referred to as the hub-to-tip ratio. The radius at the hub and the radius at the tip may both be measured at the leading edge (or the axially forwardmost) edge of the blade. The hub-to-tip ratio refers, of course, to the gas-washed portion of the fan blade, i.e. the portion that is located radially outside any platform.

The radius of the fan may be measured between the engine centerline and the tip of a fan blade at its leading edge. The fan diameter (which may generally be twice the radius of the fan) may be greater than (or on the order of) any of: 250 cm (about 100 inches), 260 cm, 270 cm (about 105 inches), 280 cm (about 110 inches), 290 cm (about 115 inches), 300 cm (about 120 inches), 310 cm, 320 cm (about 125 inches), 330 cm (about 130 inches), 340 cm (about 135 inches), 350 cm, 360 cm (about 140 inches), 370 cm (about 145 inches), 380 (about 150 inches) cm or 390 cm (about 155 inches). The fan diameter may be in a closed range bounded by any two of the values in the previous sentence (i.e. the values may represent upper or lower bounds).

The rotational speed of the fan may vary during operation. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range from 1700 rpm to 2500 rpm, for example in the range of between 1800 rpm to 2300 rpm, for example in the range of between 1900 rpm to 2100 rpm. Purely by way of further non-limitative example, the rotational speed of the fan at cruise conditions for an engine having a fan diameter in the range of between 320 cm to 380 cm may be in the range of between 1200 rpm to 2000 rpm, for example in the range of between 1300 rpm to 1800 rpm, for example in the range of between 1400 rpm to 1600 rpm.

In use of the gas turbine engine, the fan (with the associated fan blades) rotates about a rotational axis. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as the fan tip radius at the leading edge multiplied by the angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (with all units in this paragraph being Jkg⁻¹ K⁻¹/(ms⁻¹)²) The fan tip loading may be in a closed range bounded by any two of the values in the previous sentence (i.e. the values may represent upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements, the bypass ratio may be greater than (or on the order of): 10, 10.5, 11, 11.5, 12, 12.5, 13, 13.5, 14, 14.5, 15, 15.5, 16, 16.5, or 17. The bypass ratio may be in a closed range bounded by any two of the values in the previous sentence (i.e. the values may represent upper or lower bounds). The bypass duct may be substantially annular. The bypass duct may be radially outside the core engine. The radially outer surface of the bypass duct may be defined by a nacelle and/or a fan housing.

The overall pressure ratio of a gas turbine engine as described and/or claimed herein may be defined as the ratio of the stagnation pressure upstream of the fan to the stagnation pressure at the exit of the highest pressure compressor (before entry into the combustion device). By way of non-limitative example, the overall pressure ratio of a gas turbine engine as described and/or claimed herein at cruising speed may be greater than (or on the order of): 35, 40, 45, 50, 55, 60, 65, 70, 75. The overall pressure ratio may be in a closed range bounded by any two of the values in the previous sentence (i.e. the values may represent upper or lower bounds).

Specific thrust of an engine may be defined as the net thrust of the engine divided by the total mass flow through the engine. At cruise conditions, the specific thrust of an engine as described and/or claimed herein may be less than (or on the order of): 110 Nkg^{-ttttttt1} s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in a closed range bounded by any two of the values in the previous sentence (i.e. the values may represent upper or lower bounds). Such engines may be particularly efficient as compared to conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in a closed range bounded by any two of the values in the previous sentence (i.e. the values may represent upper or lower bounds). The thrust referred to above may be the maximum net thrust at standard atmospheric conditions at sea level plus 15 deg C. (ambient pressure 101.3 kPa, temperature 30 deg C.), with the engine being static.

In use, the temperature of the flow at the entry to the high pressure turbine may be particularly high. This temperature, which may be referred to as TET, may be measured at the exit to the combustion device, for example immediately upstream of the first turbine vane, which itself may be referred to as a nozzle guide vane. At cruise, the TET may be at least (or on the order of): 1400 K, 1450 K, 1500 K, 1550 K, 1600 K or 1650 K. The TET at cruise may be in a closed range bounded by any two of the values in the previous sentence (i.e. the values may represent upper or lower bounds). The maximum TET in use of the engine may be, for example, at least (or on the order of): 1700 K, 1750 K, 1800 K, 1850 K, 1900 K, 1950 K or 2000 K. The maximum TET may be in a closed range bounded by any two of the values in the previous sentence (i.e. the values may represent upper or lower bounds). The maximum TET may occur, for example, at a high thrust condition, for example at a maximum take-off (MTO) condition.

A fan blade and/or aerofoil portion of a fan blade as described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example at least a part of the fan blade and/or aerofoil may be manufactured at least in part from a metal, such as a titanium based metal or an aluminum based material (such as an aluminum-lithium alloy) or a steel based material. The fan blade may comprise at least two regions that are manufactured by using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be present in the form of a dovetail that may be inserted into a corresponding slot in the hub/disc and/or may engage with the same in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow for the exit area of the bypass duct to be varied during operation. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may refer to the cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85, or in the range from 0.8 to 0.85. Any single speed within these ranges may be the cruise condition. For some aircrafts, the cruise conditions may be outside these ranges, for example below Mach 0.7 or above Mach 0.9.

Purely by way of example, the cruise conditions may correspond to standard atmospheric conditions at an altitude that is in the range from 10000 m to 15000 m, for example in the range from 10000 m to 12000 m, for example in the range from 10400 m to 11600 m (around 38000 ft), for example in the range from 10500 m to 11500 m, for example in the range from 10600 m to 11400 m, for example in the range from 10700 m (around 35000 ft) to 11300 m, for example in the range from 10800 m to 11200 m, for example in the range from 10900 m to 11100 m, for example on the order of 11000 m. The cruise conditions may correspond to standard atmospheric conditions at any given altitude in these ranges.

Purely by way of example, the cruise conditions may correspond to the following: a forward Mach number of 0.8; a pressure of 23000 Pa; and a temperature of −55 deg C.

As used anywhere herein, “cruise” or “cruise conditions” may refer to the aerodynamic design point. Such an aerodynamic design point (or ADP) may correspond to the conditions (comprising, for example, one or more of the Mach Number, environmental conditions and thrust requirement) in which the fan is designed to operate. This may mean, for example, the conditions at which the fan (or the gas turbine engine) is designed to have optimum efficiency.

During operation, a gas turbine engine as described and/or claimed herein may operate at the cruise conditions defined elsewhere herein. Such cruise conditions may be determined by the cruise conditions (for example the mid-cruise conditions) of an aircraft to which at least one (for example two or four) of the gas turbine(s) engine may be mounted in order to provide propulsive thrust.

The skilled person will appreciate that, except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

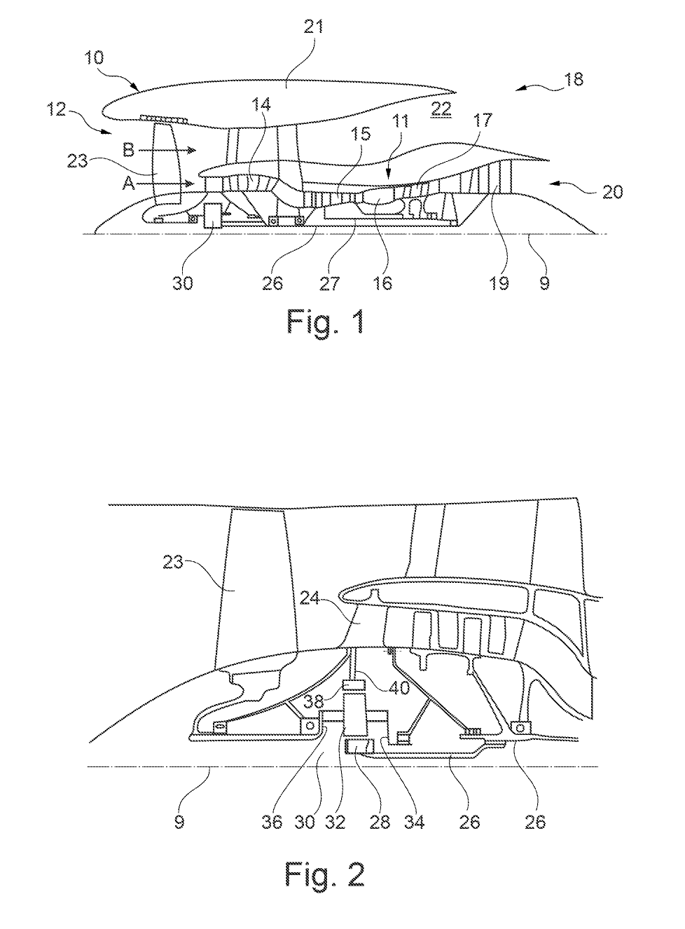

FIG. 1 shows a lateral sectional view of a gear fan engine;

FIG. 2 shows an enlarged view of a lateral sectional view of the front part of the engine according to FIG. 1;

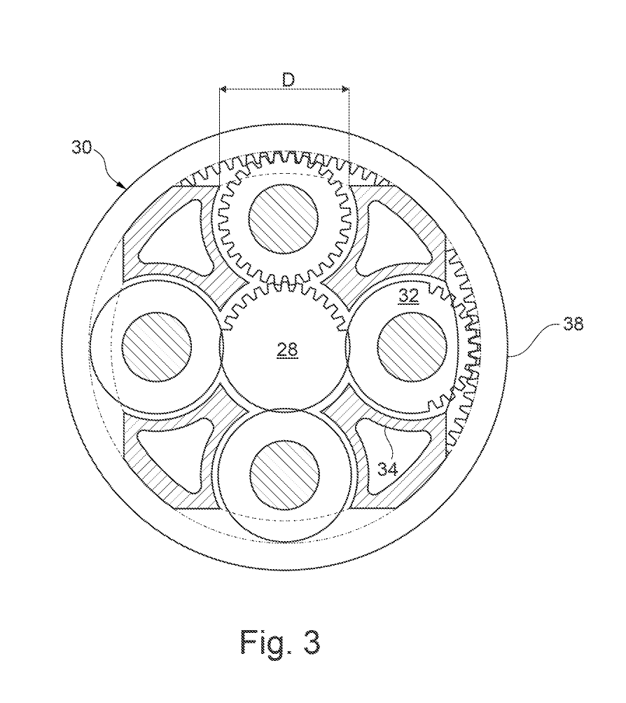

FIG. 3 shows a schematic view of a planetary carrier for planetary gears;

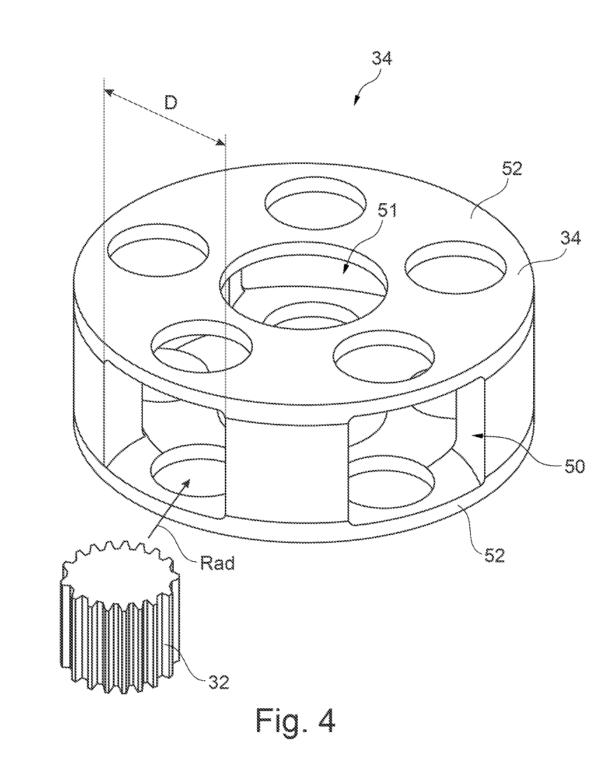

FIG. 4 shows a perspective view of an embodiment of a planetary carrier with a planetary gear before the radial insertion;

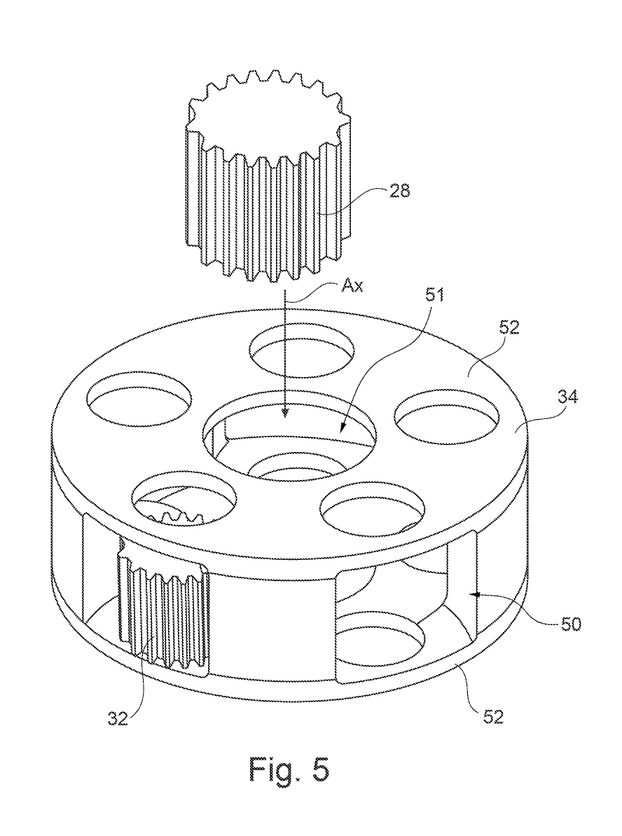

FIG. 5 shows a perspective view of a planetary carrier embodiment according to FIG. 4 with a sun gear before axial insertion;

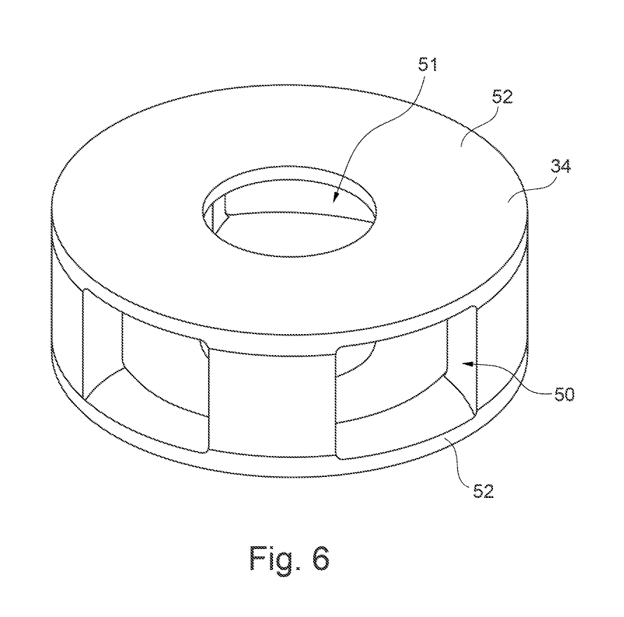

FIG. 6 shows a perspective view of a further embodiment of a planetary carrier, with side walls of the planetary carrier being embodied in a hole-free manner.

FIG. 1 describes an aircraft engine 10 having a principal rotational axis 9. The engine 10 comprises an air intake 12 and a fan 23 that generates two airflows: a core airflow A through a core engine 11 and a bypass airflow B.

The core engine 11 comprises, as viewed in the axial flow direction, a low-pressure compressor 14, a high-pressure compressor 15, combustion device 16, a high-pressure turbine 17, a low-pressure turbine 19 and a core engine exhaust nozzle 20. A nacelle 21 surrounds the aircraft engine 10 and defines the bypass channel 22 (also referred to as the subsidiary flow channel) and a bypass exhaust nozzle 18. The bypass airflow B flows through the bypass channel 22. The fan is driven by the low-pressure turbine 19 via the shaft 26 and a planetary gearbox 30.

During operation, the airflow A in the core engine 11 is accelerated and compressed by the low-pressure compressor 14, wherein it is directed into the high-pressure compressor 15 where further compression takes place. The air that is discharged from the high-pressure compressor 15 in a compressed state is directed into the combustion device 16 where it is mixed with fuel and combusted.

The resulting hot combustion gases are guided through the high-pressure turbine 17 and the low-pressure turbine 19, which are driven by the combustion gasses. Subsequently, the combustion gasses are discharged through the core exhaust nozzle 20 and provide a portion of the total thrust. The high-pressure turbine 18 drives the high-pressure compressor 15 via a suitable interconnecting shaft 27. The fan 23 usually provides the greatest portion of the propulsive thrust. In the present case, the planetary gearbox 30 is embodied as a reduction gear to reduce the rotational speed of the fan 23 as compared to the driving turbine.

An exemplary arrangement for a geared fan arrangement of an aircraft engine is shown in FIG. 2.

The low pressure turbine 19 (see FIG. 1) drives the shaft 26, which is coupled to a sun gear 28 of the planetary gearbox 30. Located radially outwardly of the sun gear 28 and intermeshing therewith is a plurality of planetary gears 32 that are coupled with each other by a planet carrier 34. The planet carrier 34 forces the planetary gears 32 to precess around the sun gear 28 in synchronicity whilst enabling each planet gear 32 to rotate about its own axis. Via connections 36, the planet carrier 34 is coupled to the fan 23 in order to cause its rotation about the rotational axis 9. An annulus or ring gear 38 is coupled radially outside of the planetary gears 32 and intermeshing therewith, connected via connections 40 [to?] of a stationary supporting structure 24. This structural design represents an epicyclic planetary gearbox 30.

Note that the terms “low pressure turbine” and “low pressure compressor” as used herein may be taken to refer to the turbine stages with the lowest pressure and the compressor stages with the lowest pressure (i.e., not including the fan 23) and/or refer to the turbine and compressor stages that are connected by the interconnecting shaft 26 with the lowest rotational speed in the engine 10 (i.e., not including the gearbox output shaft that drives the fan 23). A “low pressure turbine” and a “low pressure compressor” referred to herein may alternatively also refer to an “intermediate pressure turbine” and an “intermediate pressure compressor”. Where such alternative nomenclature is used, the fan 23 may be referred to as a first or lowest pressure stage.

The planetary gearbox 30 is shown by way of example in greater detail in FIG. 3, wherein some of the features will be discussed in more detail in connection with the embodiments described herein. The sun gear 28, planetary gears 32 and the ring gear 38 respectively have teeth at their circumference to intermesh with the other gears. However, for reasons of clarity only exemplary portions of the teeth are illustrated in FIG. 3. Here, four planetary gears 32 are illustrated, although it will be apparent to the person skilled in the art that more or fewer planetary gears 32 may be provided within the scope of the claimed invention. Practical applications of a planetary epicyclic gearbox 30 generally comprise at least three planetary gears 32.

The planetary gearbox 30 illustrated by way of example in FIGS. 2 and 3 is an epicyclic planetary gearbox since the planetary carrier 34 is connected in a rotatable manner, i.e. above all in a driveable manner, to the fan 23 via a shaft.

However, it is also possible to use any other suitable type of a planetary gearbox 30.

By way of further example, the planetary gearbox 30 may comprise a star arrangement, in which the planet carrier 34 is supported in a fixed manner, and the ring (or annulus) gear 38 is rotatable. In such an arrangement, the fan 23 is driven by the ring gear 38. By way of further alternative example, the gear 30 may be a differential gearbox in which the ring gear 38 as well as the planet carrier 34 are both rotatable

It will be obvious that the arrangement shown in FIGS. 2 and 3 serves merely as an example, and the scope of the present disclosure also comprises various alternatives. Purely by way of example, any suitable arrangement may be used for arranging the planetary gearbox 30 in the engine 10 and/or for connecting the planetary gearbox 30 to the engine 10. By way of further example, the connections (such as the connections 36, 40 in the embodiment according to FIG. 2) between the planetary gearbox 30 and other parts of the engine 10 (such as the core engine shaft 26, the output shaft and the stationary support structure 24) may have any desired degree of stiffness or flexibility.

By way of further example, any suitable arrangement of the bearings between rotating and stationary parts of the engine 10 (for example between the input and output shafts of the planetary gearbox 30 and the fixed structures, such as for example the gearbox casing) may be used, and the disclosure is not limited to the exemplary arrangement of FIG. 2. For example, where the planetary gearbox 30 has a star arrangement, the person skilled in the art would readily understand that the arrangement of output and support connections and bearing locations would typically be different from that shown in FIG. 2.

Accordingly, the present disclosure extends to an aircraft engine 10 having any arrangement of gearbox styles (for example star arrangement or planetary arrangements), support structures, input and output shaft arrangement, and bearing locations.

Optionally, the planetary gearbox 30 may drive additional and/or alternative components (e.g. the intermediate pressure compressor and/or a booster compressor).

Other aircraft engines 10 to which the present disclosure may be applied may have alternative configurations. For example, such aircraft engines 10 may have a different number of compressors and/or turbines and/or a different number of interconnecting shafts. By way of further example, the engine 10 shown in FIG. 1 has a split flow nozzle 20, meaning that the flow through the bypass channel 22 has its own nozzle that is separate from and arranged radially outside of the core engine exhaust nozzle 20. However, this is not to be taken in a limiting manner, and any aspect of the present disclosure may also apply to engines 10 in which the flow through the bypass channel 22 and the flow through the core engine 11 is intermixed or combined by a single nozzle (in front of or upstream), which is referred to as a mixed flow nozzle. One or both nozzles may have a fixed or variable cross section (independently of whether a mixed or a partial flow is present). Whilst the example described herein relates to a turbofan engine, the disclosure may apply, for example, to any type of aircraft engine, such as an engine 10 with an open rotor (in which the fan stage 23 is not surrounded by a housing) or to a turboprop engine, for example.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

It can further be seen in FIG. 3 that the webs 53 of the planetary carrier 34 are formed in a substantially trapezoid manner.

In the following, some embodiments for a method for assembling a planetary gearbox 30 and an associated planetary carrier 34 are described.

FIG. 4 shows a perspective view of a planetary carrier 34 of a planetary gearbox 30 (not shown here). Here, the planetary carrier 34 substantially has the shape of a flat cylinder. The top and bottom side are formed by the side walls 52 of the planetary carrier 34. Respectively one circular opening 51 is arranged in the side walls 52, with the rotational axis 9 of the engine 10 extending through its center line.

At the circumference of the planetary carrier 34, in total five openings 50 are arranged. These openings 50 respectively have a width that corresponds to that of the diameter D of the planetary gear 32. The width D is shown in FIGS. 3 and 4.

FIG. 4 further shows that at least one of the planetary gears 32 is inserted in the radial direction from the outside into the opening 50 that is located at the circumference of the planetary carrier 34. The radial insertion direction of the planetary gear is shown by an arrow in FIG. 4. In general, all—here five—planetary gears 32 are inserted into the respective openings 50, wherein, with a view to a clear rendering, only one planetary gear 32 is shown in FIG. 4.

Subsequently, the at least one planetary gear 32 is radially moved in the outward direction to the circumference of the planetary carrier 34.

FIG. 5 shows the planetary carrier 34 of FIG. 4, with the sun gear 28 now being inserted in the axial direction (arrow Ax) through an opening 51 in the center of the flat side wall 52 of the planetary carrier 34.

Subsequently, at least one of the planetary gears 32 is guided radially inward to come into engagement with the sun gear 28.

A particularly stable design of the planetary carrier 34 results when, except for the central opening 51, both side walls 52 are formed in a hole-free manner, as shown by way of example based on FIG. 6.

It is to be understood that the embodiments described herein are not meant to be restrictive, and that various modifications and improvements can be realized without departing from the concepts described herein. Except where they are mutually exclusive, any of the features can be used separately or in combination with any other features, and the disclosure extends to all combinations and sub-combinations of one or multiple features described herein and includes the same.

### PART LIST

9 rotational axis
10 aircraft engine
11 core engine
12 air intake
14 compressor, low-pressure compressor
15 high-pressure compressor
16 combustion device
17 high-pressure turbine
18 bypass channel exhaust nozzle
19 turbine, low-pressure turbine
20 core engine exhaust nozzle
21 nacelle
22 bypass channel (subsidiary flow channel)
23 fan
24 stationary support structure
26 core engine shaft
27 connecting shaft
28 sun gear
30 planetary gearbox
32 planetary gears
32′, 32″ planetary gear elements
34 planetary carrier for planetary gears
36 connections
38 ring gear
40 connections
50 opening at the circumference of the planetary carrier
51 opening in in the center of the planetary carrier
52 side wall of the planetary carrier
53 web of the planetary carrier
A air flow through the core engine
B bypass air flow
D diameter of a planetary gear, width of a radial opening of the planetary carrier
Ax axial direction
Rad radial direction

1. A method for assembling a planetary gearbox, wherein the planetary gearbox has a planetary carrier for mounting planetary gears, and wherein
a) at least one of the planetary gears is inserted in the radial direction from the outside into an opening that is located at the circumference of the planetary carrier,
b) the at least one planetary gear is then moved radially in the outward direction to the circumference of the planetary carrier, subsequently
c) a sun gear is inserted through an opening in the center of the flat side wall of the carrier, and subsequently
d) the at least one planetary gear is moved radially inward for engagement with the sun gear.

2. The method according to claim 1, wherein the at least one planetary gear is inserted with an angular pre-alignment into the radial opening of the planetary carrier.

3. The method according to claim 1, wherein the at least one planetary gear is displaced in the planetary carrier by an angular amount with respect to the rotational axis of the planetary carrier for insertion into a bulge in the radial housing of the planetary carrier.

4. The method according to claim 1, wherein planetary gears that respectively have two planetary gear elements that are arranged in parallel to each other, wherein the planetary gear elements respectively have a helical gearing, and the planetary gear elements are arranged in such a manner that the helical gearings are counter-rotating.

5. The method according to claim 1, wherein an axial setting of the sun gear is performed following the movement of the at least one planetary gear radially inward for engagement with the sun gear.

6. Planetary carrier of a planetary gearbox,
wherein
radial openings at the circumference, which are adjusted to the size and shape of the at least one planetary gear.

7. The planetary carrier according to claim 6, wherein at least one opening of the planetary carrier has a rectangular cross section, wherein the width is larger than the diameter of the at least one planetary gear.

8. The planetary carrier according to claim 6, wherein at least one web of the planetary carrier has a trapezoid cross section.

9. The planetary carrier according to claim 6, wherein, except for the central opening, the side walls of the planetary carrier are embodied in a hole-free manner.

10. An aircraft engine with
a core engine, comprising a turbine, a compressor and a core engine shaft for connecting the turbine to a compressor,
a fan upstream of the core engine, wherein the fan has a plurality of blades, and
a planetary gearbox that is connected to the core engine shaft at the entry side, and is connected to the fan on the exit side towards the drive in such a manner that the rotational speed of the fan is lower than the rotational speed of the core engine shaft, and
the planetary gearbox has a planetary carrier according to claim 6.
